(19) United States
(12) Patent Application Publication
(10) Pub. No.: US 2025/0005626 A1
(43) Pub. Date: Jan. 2, 2025

(54) SYSTEM AND METHOD FOR PREDICTIVE CUSTOMER TRAIT LEARNING AND PERSONALIZATION

(71) Applicant: Uknomi, Inc., Dallas, TX (US)

(72) Inventors: James Strieby, Edwardsville, TX (US); Srinivas Guddati, Flower Mound, TX (US); Johan Van Der Westhuizen, Dallas, TX (US)

(73) Assignee: Uknomi, Inc., Dallas, TX (US)

(21) Appl. No.: 18/343,678

(22) Filed: Jun. 28, 2023

(51) Int. Cl. G06Q 30/0251; G06Q 30/0207

(52) U.S. Cl. CPC G06Q 30/0269; G06Q 30/0224; G06Q 30/0255

(57) ABSTRACT

A system and method for predictive customer trait learning and personalization. The method includes receiving a plurality of external signals, determining a customer trait estimate score based on the received external signals, determining a customer suitability score, and constructing an order recommendation based on the customer trait estimate score and the customer suitability score and a plurality of factors. The customer trait estimate score is a numerical value reflecting the confidence in the estimation based on a first learning algorithm. The customer suitability score is continuously improved by a second learning algorithm.

### BACKGROUND OF THE INVENTION

### Field of the Invention

The present invention is generally related to automated customer recognition and tracking, and more particularly to a system and method for predictive customer trait learning and personalization.

### Discussion of the Background

Retail locations often build up a loyal base of customers who repeatedly frequent the location. These locations sometimes utilize reward programs for the purpose of encouraging the customer to return. However, at existing retail locations there does not exist technologies that efficiently and automatically recognize and track customers. The lack of such automated recognition limits the ability of the retail location to track and optimize the operation of the retail, recognize customer trends, and enhance the customer experience at the retail location.

Thus, there currently exist deficiencies in customer trait learning and personalization at a retail location.

### SUMMARY OF THE INVENTION

Accordingly, one aspect of the present invention is to provide a computer program product embodied on a computer readable medium for predictive customer trait learning and personalization. The computer program product includes (i) a first computer code for receiving a plurality of external signals; (ii) a second computer code for determining a customer trait estimate score based on the received external signals, (iii) a third computer code for determining a customer suitability score, and (iv) a fourth computer code for constructing an order recommendation based on the customer trait estimate score and the customer suitability score and a plurality of factors. The customer trait estimate score is a numerical value reflecting the confidence in the estimation based on a first learning algorithm. The customer suitability score is continuously improved by a second learning algorithm.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1A-1E are block diagrams illustrating systems for predictive customer trait learning and personalization in accordance with an embodiment of the present invention; and

FIG. 2A-2I are flow charts illustrating a method for predictive customer trait learning and personalization in accordance with an embodiment of the present invention.

### DETAILED DESCRIPTION THE PREFERRED EMBODIMENTS

Referring now to the drawings, wherein like reference numerals designate identical or corresponding parts throughout the several views, preferred embodiments of the present invention are described.

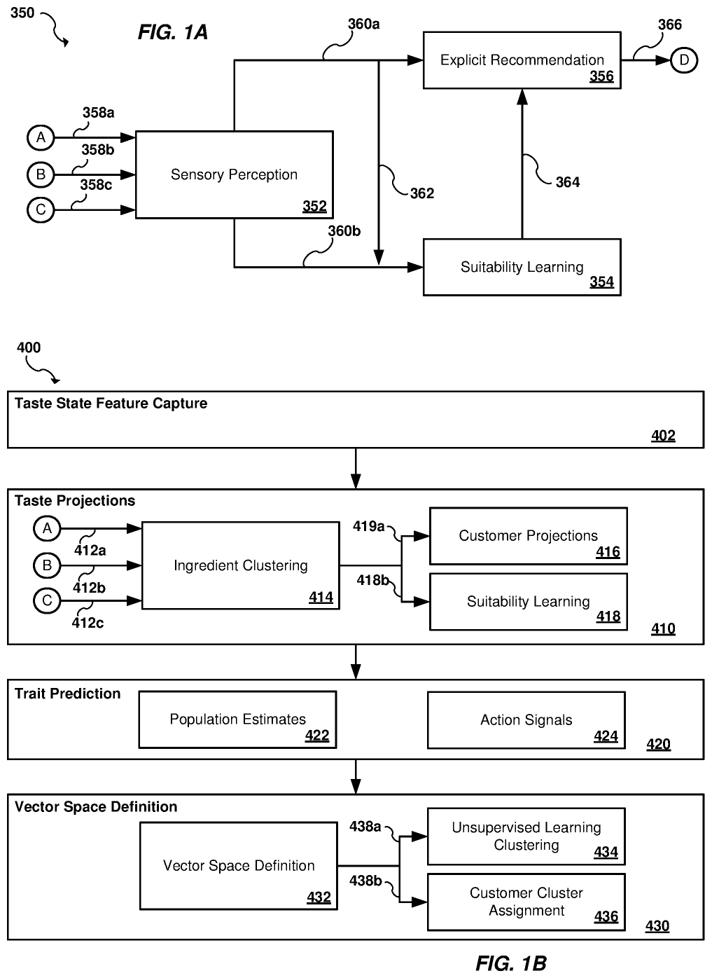

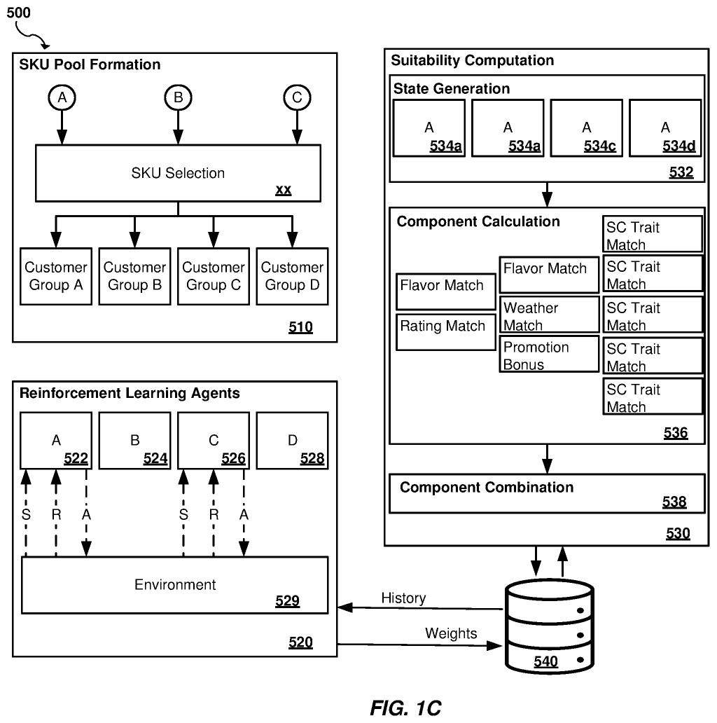

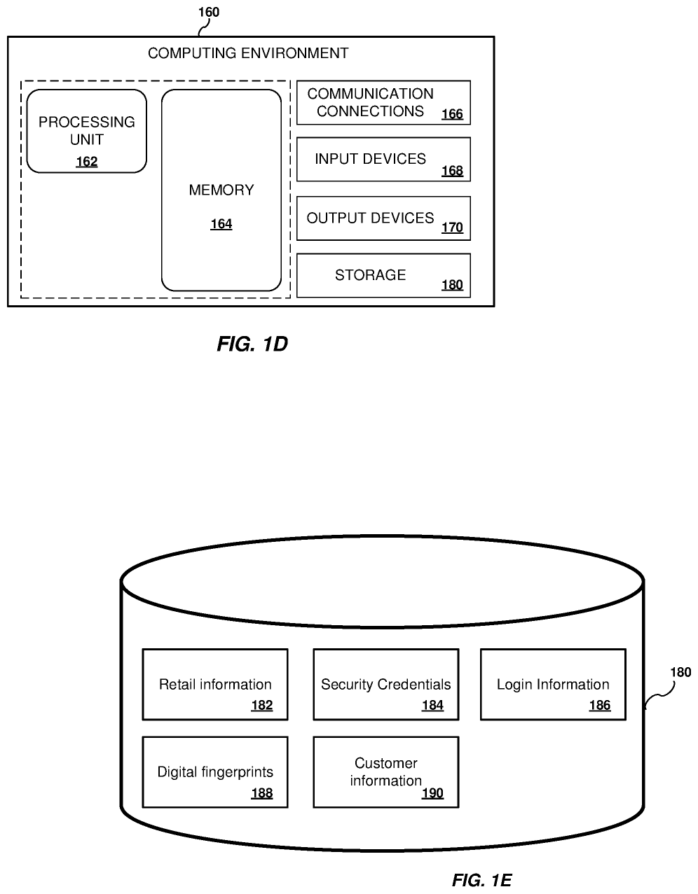

Referring to FIGS. 1A-1E, block diagrams illustrating systems for predictive customer trait learning and personalization in accordance with a embodiment of the present invention, is shown. As shown in FIG. 1A, the present invention includes a sensory perception node 352, a suitability learning node 354, and an explicit recommendation node 356 for learning the tastes and preferences of the customer and for producing a customer trait estimate. The present invention utilizes external signals to learn the tastes and preferences of customers. The learned tastes and preferences of customers are used in the production of curated menus and bespoke order recommendations for each customer. The learning network also provide customer trait estimates to third parties, including without limitation, QSR service agents.

Sensory perception node 352 receives external signals 358a-358c from various sources and outputs state features and intermediate features which are then used as input to the suitability learning node 354 and the explicit recommendation node 356. The sensory perception node 352 receives external signals 358a-358c from various sources including without limitation clients (QSRs), customers, and weather sources. External signals 358a-358c include without limitation, data related to menu promo orders, forecast actuals and ratings, menus, promos, and orders. These external signals take the form of many different state features captured and updated by the present invention each time a customer places a new order. These features are utilized by the suitability learning node 354 and explicit recommendation node 356. Sensory perception node 352 produces more complex intermediate features, as well as customer trait estimates whose values reflect the confidence in the estimation.

Suitability learning node 352 incorporates a learning algorithm which continuously improve its computation of suitability of learned customer traits. It computes suitability scores for customer Cluster-to-SKU pairings using external signals 360b relating the type of customer, weather and time states for which the calculation is being performed.

Explicit recommendation node 356 receives state features 360a and suitability scores 364 to construct order recommendations capable of accounting for various factors. These factors include, without limitation, multiple SKUs, multiple persons, kids' menu constraints, prohibited items, and the like. State features 360a include, without limitation, order component patterns and customer trait values.

As shown in FIG. 1B, the sensory perception node 352 includes, without limitation, a state feature capture 402, a taste projection 410 and a trait prediction 420. The state feature capture 402 adds context to and records history in the form of state features. These include, without limitation, basic order information features, contextual features and updating features. Basic order information features include, without limitation, the customer's ordered items, counts, prices, time ordered, and the like. Contextual features include, without limitation, the number of implied persons on the order, the daily active time category the order falls into, the formulaic health scores of the items ordered, and the like. Updating features are statistical aggregations of other features, such as means, standard deviations, and the like.

For instance, assuming a customer original order includes the following information:

### Example 1

| | |
|---|---|
| Original Order | Order 1234, John Doe, Chicken Burger, |
| | Oct. 10, 2021 11:20 AM, $12 |

Based on the above non-limiting exemplary original order shown in Example 1, the basic features, contextual features and dirty event above are derived by the sensory perception node 352.

| | |
|---|---|
| Basic Features | Count: 1, Item:1, Price: $12 |
| Contextual Features | Persons: 1, Time Category: Lunch, Health Score: 25 |
| Dirty Event | Order Upload |

Taste projections 410 are a set of specialized intermediate features which allow a customer's entire order history to be projected into unique-to-the-individual taste patterns into universal ingredient spaces. This projection is without limitation according to the number of shared molecular flavor compounds (also referred to herein as the “compound dataset”) and according to customer ratings. Each output cluster represents a feature in a particular ingredient cluster space where individual values can be derived for each customer as the number of times an ingredient present in the cluster has been order by the customer. The same approach can be applied to an individual item. The individual item count is the number of ingredients that are part of the item and present in each cluster, according to the number of shared molecular flavor compounds (also referred to herein as the “flavor compound dataset”), and according to customer ratings. Each output cluster then represents a feature in that particular ingredient cluster space where individual values can be derived for each customer as the number of times an ingredient present in the cluster has been ordered by the customer.

### Example 2

| | |
|---|---|
| Flavor Compounds | Mustard has 5 counts smoky flavor |
| Ratings | John Doe gave 5 Star for Chicken Burger, |
| | Rob Smith gave 4 star for Chicken Burger |
| Ingredient | kfcChickenBurger has kfcChicken, kfcLettuce: |
| Transformation | Dirty Event: New Menu Item (manual) |
| | kfcChickenBurger has uChicken, uLettuce |
| | uChicken, uLettuce Ratings and FlavorIds is |
| | built already as one time |

In the above non-limiting example shown in Example 2, the sensory perception node 352 receives taste projections for flavor compounds, ratings, and ingredient transformation.

Based on Example 1, the following ingredient clusters are created:

| | |
|---|---|
| Flavor Clusters | [F1: Cheese, Mustard], [F2: Jalapenos, Pickles] |
| Rating Clusters | [R1: Cheese Pickles have correlated ratings], |
| | [R2: Jalapenos, Mustard] |

The above ingredient clusters are used to create the following customer projections:

| | |
|---|---|
| Customer Projections | John Doe, looking at his order history |
| | so far: Dirty Event: On Every Order |
| Flavor Projections | [F1: 35], [F2:23] - formulae that |
| | include recency and frequency . . . not |
| | just counts |
| Rating Projections | [R1: 25] [R2: 78] |

The above ingredient clusters are also used to create the following SKU projections:

| | |
|---|---|
| SKU Projections | kfcCB Dirty Event: On Every Menu Item |
| Flavor Projections | [F1: 2], [F2: 1] |
| Rating Projections | [R1: 3], [R2: 0] |

Trait Prediction 420 produces an estimated value on a 1-5 scale of the strength of a particular trait in a customer. The default customer traits include, without limitation, taste explorer, spicy lover, sweet tooth, spend conscious (also referred to herein “economizer), and health conscious.

Each trait's estimate may include without limitation a population signal 422 and/or action signals 424. A population signal is based on the historical menu items ordered relative to the population of menu items. Action signals are based on specific actions detectable via POS order lines. Trait Prediction can function from a single order in history.

Population Estimates 422 are determined by (i) calculating some average value for each trait, for each customer, and (ii) computing each customer's percentile of the average value for each trait, (iii) a calculation based on the customer traits below:

| | |
|---|---|
| Taste | Average cosine distance between all menu item flavor vectors |
| Explorer | present in history |
| Health | Average health score value of orders: |
| Conscious | % Daily Value of Calories, Fat, Sugar, Sodium (summed); |
| | Proportion of main ingredients that are animal based |
| | (summed with above); and |
| | Final population estimate is (1-Percentile) |
| Spend | Average spend per implied person |
| Conscious | Final Population Estimate is (1-Percentile) |
| | These next two estimates require the onboarding |
| | of any menu to have all items labeled with simple |
| | Booleans isSpicy, hasSweet |
| Spicy | Proportion of orders containing spicy items |
| Lover | If only 1 order in history and it has a spicy item, set = 50%, |
| | not 100% |
| Sweet | Proportion of orders containing sweet items |
| Tooth | If only 1 order in history and it has a sweet item, set = 50%, |
| | not 100% |

### Example 3

Assuming there are order histories for N customers,
the customer traits are calculated for each customer
of the N customers using the logic described above.

| | |
|---|---|
| Taste Explorer | Customer 1: TE: 80, Customer 2: TE: 75 . . . |
| Statistical | Assume that the taste explorer (TE) for a |
| | given customer is calculated to be 30. Where |
| | here the 30 falls in as a percentile with |
| | the distribution of the N customers is used |
| | to determine the customer's trait |
| Supervised | A customer answered profile questions in an |
| Learning | interesting way that he is not that big of a |
| | taste explorer and he is actually at TE score of 23 |

An action signal 424 is associated with a particular trait. Action signals 424 include, without limitation, an occurrence increment value, a nonoccurrence decrement value, and a minimum post-decrement value. Action signals 424 reflect both frequency and recency or said another way, they can grow and fade over time.

According to one embodiment, customer classifications use a static vector space definition 430 having customer trait predictions 420 and taste projections 410 as input. According to another embodiment, a learning algorithm determines the best features for vector space definition 430. Customers are clustered using an unsupervised learning algorithm during client initializations and full-refresh process flows. Alternatively new customers are assigned to the nearest cluster in new customer initialization flow.

### Example 4

A new customer Rob Smith just placed his first order Order 555. Using all the above components, what can we say about Rob Smith.
Customer clusters are based on 17 dimensions-6 Traits, 7 FC, 4 RC
Cluster ABC: [John Doe, Johann, Srinivas . . . ] [Adnan, Tinca, Pieter . . . ]
[CC1: CT 1-6, FC 1-7, RC 1-4]

The customer kept placing orders and the present invention started accumulating his history. Now we have 100 orders from Rob Smith. What do we do at this time to learn more about Rob Smith.
Either move Rob Smith to other cluster OR
Evaluate the clusters itself when we cross that threshold

Vector space definition looks at everything going on (deep learning, neural) and define the new dimensions from the 17 that we started with

Suitability learning node 354 receives input of state and intermediate features to produce customer-item pair suitability scores that are specific to the active weather-time states.

SKU pool formation 510 receives all items from a customer cluster's history and selects a subset for which suitability scores are to be calculated. This is done according to the average customer trait values for the cluster and considering the active weather-time states as well. An example of considering the active weather-time states includes making sure hot days tend to have more options that are rated as beneficial on a hot, sunny day. SKU pool formation 510 selects a subset for which suitability scores are to be calculated.

### Example 5

Assume that the following are the inputs to the suitability learning node:

| | |
|---|---|
| Customer Clusters | [CL1 . . . CLn] and with each cluster having a set of orders OS1, |
| | OS2 . . . |
| Predefined Weather | Hot (<75), Cold (<40), Warm (Anywhere between) |
| States | |
| Client Time States | kfcBreakfast, kfcLunch . . . These states will suggest what menu items |
| | are available in what time window |
| uKnowmi Time States | uBreakfast, uLunch, uDinner to define generic time windows |
| Menu Items | MI1, MI2 . . . |
| Menu Item Traits | Trait (Health, spend . . . ) related scores: Each menu item is tagged |
| | with its trait score based on the ingredients and other parameters. |
| | This is initially an implementation effort as part of onboarding |
| | the client menus, but there is an opportunity to derive based on |
| | the order history and formulae. |
| | Time is automatically done based on Client time windows. Menu |
| | for Breakfast vs. Lunch |
| | Weather score can be derived from order history or alternatively |
| | can be manual. For instance, ice cream is good on hot days. |

From the above inputs, the system computes the customer cluster menu items to represent the set of menu items that are meaningful for a given customer cluster, at a given time state and weather state. This is done by matching average scores of cluster on traits with menu item features, and matching affinity of time and weather to that menu item.
CL1, Hot, kfcBreakfast: [MI1, MI2 . . . ],
CL1, Warm, KfcBreakfast: [MI1, MI3]

For each cluster menu items pool, suitability computation 532 computes the suitability score for each menu as a weighted combination of match scores. Weights of the components are based on how important that component is to the cluster. For example, if cluster has a heavy health conscious score, the weight for the health conscious match component is given high. This may implemented as static values based on domain knowledge. Alternatively, the relearning algorithm continually refine them. A match score is a numerical value representing how close the match between menu item and cluster score for the given trait.

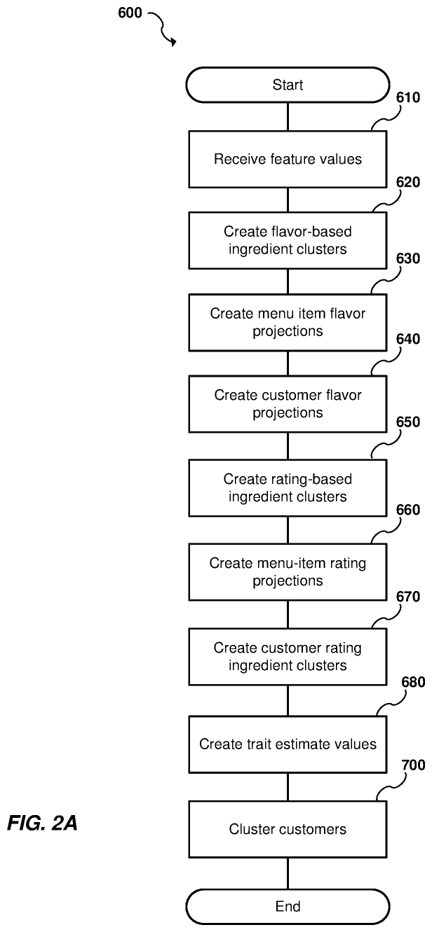

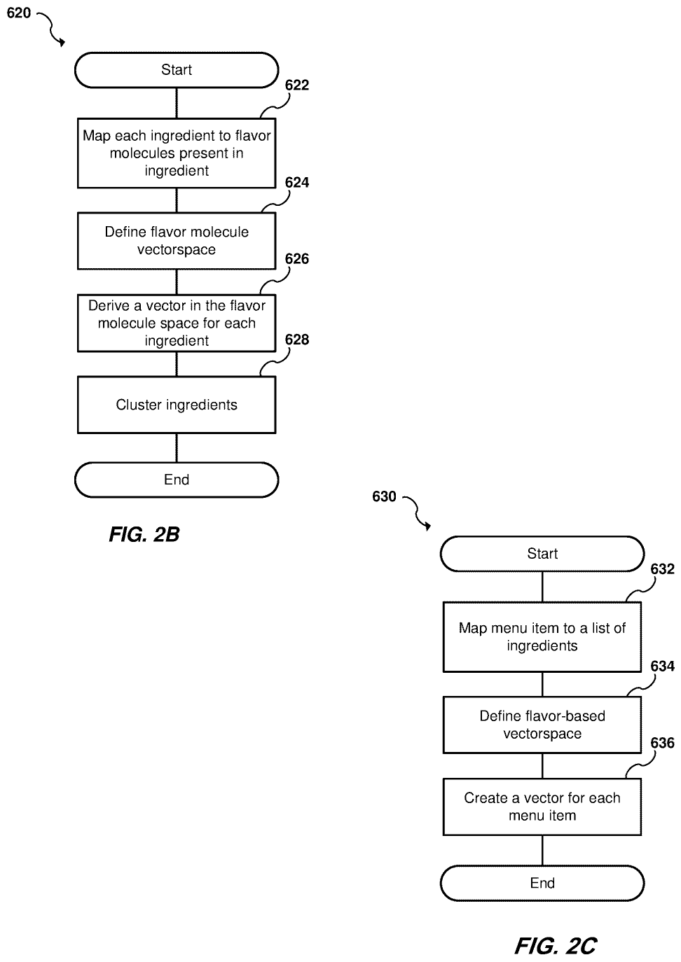

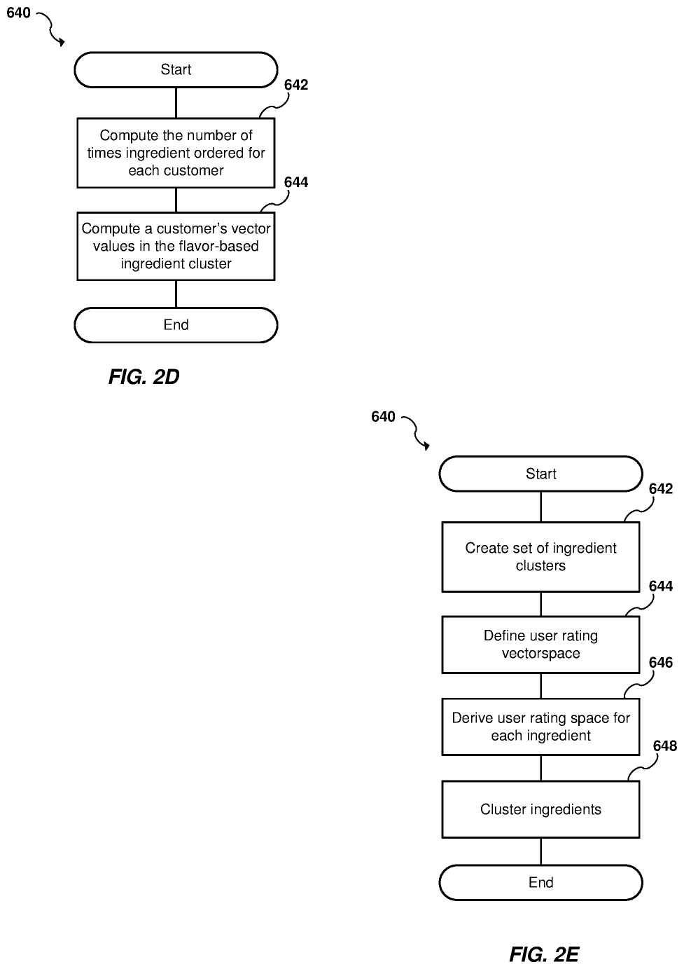

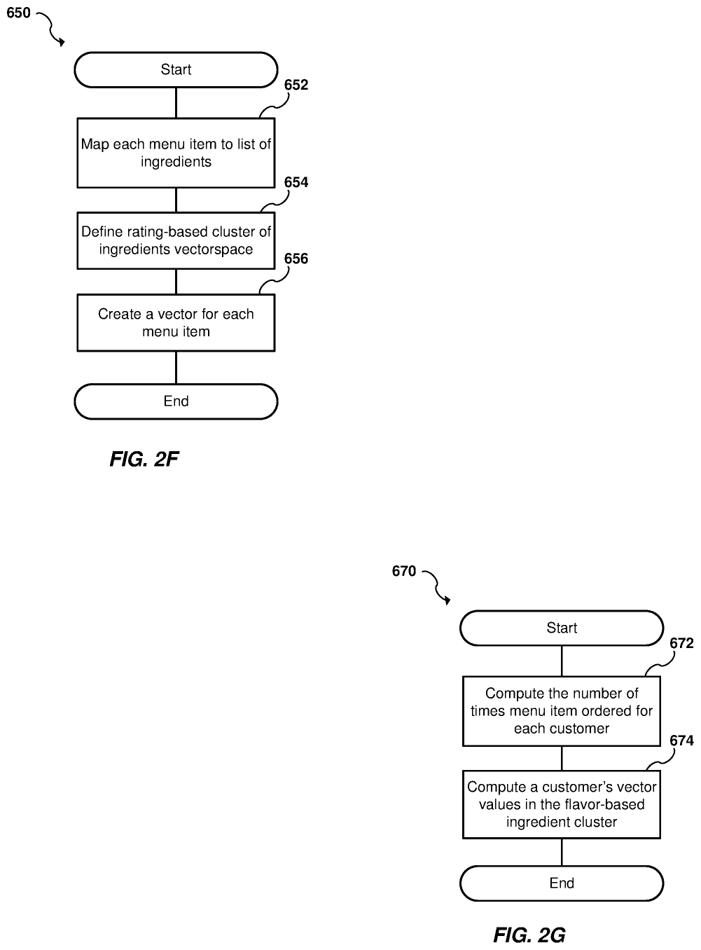

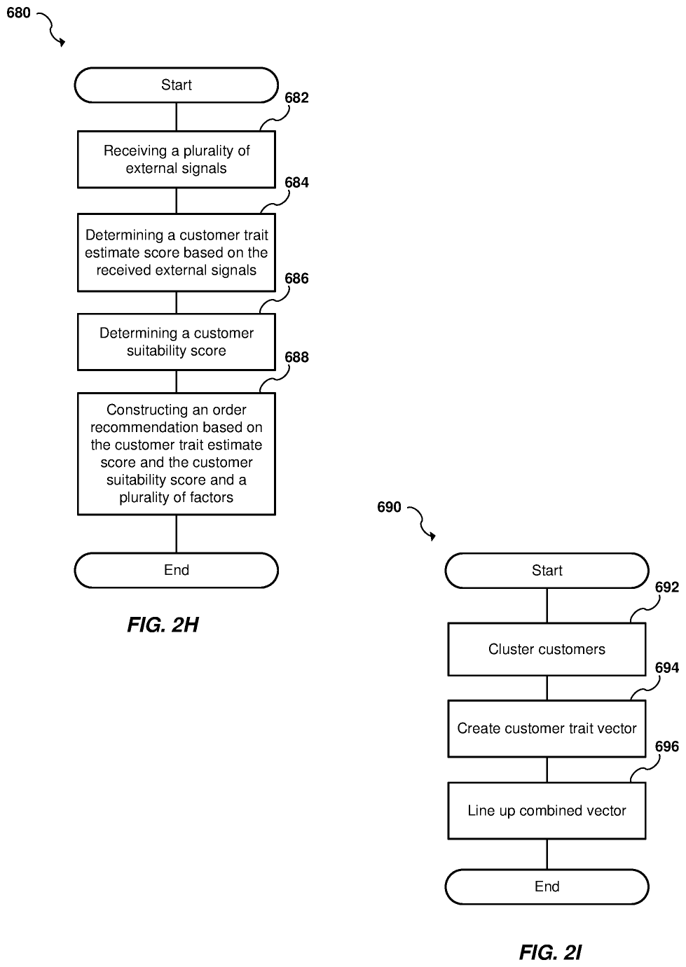

Referring to FIGS. 2A-2I, flow charts illustrating a method for predictive customer trait learning and personalization in accordance with an embodiment of the present invention, are shown. As shown in FIG. 2A, at block 610, feature values are received and stored each day related to new orders that occurred that day, menu item changes, and the like. Flavor-based Ingredient Clusters are created, at block 620. At block 630, menu Item flavor projections are created. Customer flavor projections are created, at block 640. At block 650, rating-based ingredient clusters are created. Menu item rating projections are created, at block 660. At block 670, customer rating projections are created. Trait estimate values are created, at block 680. At block 690, customers are clustered.

Detail for block 620 is shown in FIG. 2B. At block 622, a stored data set of over 300 ingredients, are mapped to a list of flavor molecules present in the ingredient. A flavor molecule vectorspace is defined where each flavor molecule represents an individual dimension in the space, at block 624. The size of a flavor molecule vector is equivalent to the number of flavor molecules in the stored dataset, currently 1,107. At block 626, for each ingredient, a vector in the flavor molecule space is derived where the value of each cell is 1 if the ingredient contains the flavor molecule represented by the cell, and 0 if it does not. Ingredients are then clustered using a modified k-means algorithm where the distance between ingredients is defined as the cosine distance between their flavor molecule vectors, at block 628.

Detail for block 630 is shown in FIG. 2C. At block 632, each menu item is mapped to a list of ingredients during initial set up. A new vectorspace can now be defined where each flavor-based cluster of ingredients represents a dimension in the space, at block 634. At block 636, for each menu item, a vector is created where the value of each cell is the number of ingredients contained by the menu item and present in the flavor-based ingredient cluster represented by that cell (typical cell values are ranging from 0-10). This vector is a menu item's flavor projection.

Detail for block 640 is shown in FIG. 2D. For each customer, a count of the number of times an ingredient has been “ordered” is computed as the number of times a menu item has been ordered by the customer that contains that ingredient, at block 642. At block 644, these individual ingredient counts are used to compute a customer's vector values in the same flavor-based ingredient cluster space from block 636. The value of each cell is now the sum of the ingredient order counts for all ingredients contained in the cluster represented by the cell. This is a customer's flavor projection.

Detail for block 650 is shown in FIG. 2E. At block 652, a stored dataset of 146k ratings (1-5) of recipes rated by 48k users is leveraged to create an additional set of ingredient clusters. A user rating vectorspace is defined where each dimension represents one of the 48k users, at block 654. At block 656, for each of the 300+ ingredients, a vector in the user rating space is derived where the value of each cell is the average rating of the user given to all recipes containing the ingredient, or 1 if the user did not rate any recipes with the ingredient. Ingredients are then clustered using a modified k-means algorithm where the distance between ingredients is defined as the cosine distance between their user rating vectors, at block 658.

Detail for block 660 is shown in FIG. 2F. At block 662, each menu item is mapped to a list of ingredients during initial set up. A new vectorspace can now be defined where each rating-based cluster of ingredients represents a dimension in the space, at block 664. At block 666, for each menu item, a vector is created where the value of each cell is the number of ingredients contained by the menu item and present in the rating-based ingredient cluster represented by that cell (typical cell values are ranging from 0-10). This vector is a menu item's rating projection.

Detail for block 670 is shown in FIG. 2G. For each customer, a count of the number of times an ingredient has been “ordered” is computed as the number of times a menu item has been ordered by the customer that contains that ingredient, at block 672. At block 674, these individual ingredient counts are used to compute a customer's vector values in the same flavor-based ingredient cluster space from block 666. The value of each cell is now the sum of the ingredient order counts for all ingredients contained in the cluster represented by the cell. This is a customer's rating projection.

Detail for block 680 is shown in FIG. 2H. At block 682, external signals are received. A customer trait estimate score is determined based on the received external signals, at block 684. The customer trait estimate score reflects the confidence in the estimation based on a first learning algorithm. At block 686, a customer suitability score is determined. The customer suitability score is continuously improved by a second learning algorithm. An order recommendation is calculated based on the customer trait estimate score and the customer suitability score and a plurality of factors, at block 688. The factors include a plurality of SKU, the party size, constraints based on age, and prohibited items.

Detail for block 690 is shown in FIG. 2I. At block 692, customers are clustered according to their combined vectors of (i) the customer flavor projection, (ii) the customer rating projection, and (iii) the customer trait vector. The customer trait vector is a simple vector where each dimension is a trait, and each customer's value for the dimension is the trait estimate, at block 694. At block 696, the combined vector is literally lining up one vector directly after another into one long vector. This is then clustered using the same modified k-means algorithm and cosine distances.

As shown in FIG. 1D, present invention includes a computer program which may be hosted on a storage medium or other computer readable medium 180 and includes instructions which perform the processes set forth herein using memory 164 and a processing unit 162 contained within a computing environment 160. The storage medium or other computer readable medium 180 can include, but is not limited to, any type of disk including floppy disks, optical disks, CD-ROMs, magneto-optical disks, ROMs, RAMS, EPROMS, EEPROMs, flash memory, magnetic or optical cards, or any type of media suitable for storing electronic instructions. The computing environment 160 may include communication connections 166, input devices 168 and output devices 170.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program product embodied on a computer readable medium for predictive customer trait learning and personalization, the computer program product comprising:
a first computer code for receiving a plurality of external signals;
a second computer code for determining a customer trait estimate score based on the received external signals, wherein the customer trait estimate score is a numerical value reflecting the confidence in the estimation based on a first learning algorithm;
a third computer code for determining a customer suitability score, wherein the customer suitability score is continuously improved by a second learning algorithm; and
a fourth computer code for constructing an order recommendation based on the customer trait estimate score and the customer suitability score and a plurality of factors.

2. The computer program product of claim 1, wherein the plurality of factors is selected from one of the group consisting of a plurality of SKU, the party size, constraints based on age, and prohibited items.

3. The computer program product of claim 1, wherein the plurality of external signals is selected from one of the group consisting of menu promotional orders, forecast actuals and ratings, menus, promotions, and customer orders.
